(19) United States
(12) Patent Application Publication
(10) Pub. No.: US 2007/0160364 A1
(43) Pub. Date: Jul. 12, 2007

(54) Vehicle mounted articulating arm

(76) Inventor: Stephen J. Peika, LaGrange, IL (US)

Correspondence Address: ROBERT L. MARSH, 54 DANADA DRIVE, P.O. BOX 4468, WHEATON, IL, 60187-4468, US

(21) Appl. No.: 11/328,387

(22) Filed: Jan. 9, 2006

(51) Int. Cl. G03B 17/00

(52) U.S. Cl. 396/428

(57) ABSTRACT

An articulating arm for retaining a camera to a two wheeled vehicle such as a bicycle includes first and second arm members with the first end of the first arm removably attachable to the seat post of a bicycle and the second end of the first arm adjustably connected to the first end of a second arm. A camera is mounted on the second end of the second arm. The connections between the various parts have locking hinges such that the orientation of the various members of the articulating arm can be set to aim the direction of the camera after which the parts are locked into place. The camera can be directed to photograph the surroundings through which the bicycle moves and record the rider on the bicycle as it moves through its surroundings.

The present invention relates to an articulating arm for retaining a camera or the like, with the arm mounted on a two wheel vehicle such as a bicycle to enable the operator of the vehicle to photograph himself and the territory through which the vehicle passes.

### BACKGROUND OF THE INVENTION

In recent years, there has been an increase in bicycle sales and bicycle usage. This has been brought on in part because of increased interest in physical fitness, but another factor has been a growing demand for activities that can be enjoyed as a family. Simultaneously, the video technology has improved significantly, resulting in smaller cameras that produce higher quality video reproductions. As a result, there has been a corresponding increase in demand to make video recordings of family bicycle outings.

To safely ride a bicycle, however, a rider must maintain both hands on the handlebars of the bicycle. A rider who attempts to use a video camera to record other bicyclists and the surrounding terrain through which the bicycles are moving, must employ at least one hand to operate the camera, thereby reducing his control of the bicycle. The risks are further compounded if the rider's eyes are directed through the viewfinder of the video camera rather than towards the pathway ahead. To reduce such risks, video camera mountings are available for attaching the video camera to the handlebars of a bicycle.

Admittedly, it is safer for a bicycle operator to use a handlebar mounted video camera than one that is hand held. Such handlebar mounted video cameras, however, have undesirable limitations. First, the scene recorded by a handlebar mounted video camera will chronically shift from left to right as the operator moves the handlebars to steer the bicycle and maintain stability. Also, existing mountings for retaining a video camera to a bicycle or the like generally cannot photograph the bicycle operator with respect to his surroundings because the camera is positioned so close to the operator that the operator's body will block any view of the operator's surroundings through which the bicycle is moving.

It would be desirable, therefore, to provide a mounting to retain a video camera to a bicycle where the camera can be positioned remote from the operator and photograph the operator with respect to his surroundings. It would also be desirable to provide a mounting for a video camera that is adjustable so as to view either the operator or the surroundings from a number angles. When the video camera is directed towards the operator, it would also be desirable that the camera be positioned sufficiently far from the operator's body such that the scene recorded by the video camera will not be overly dominated by the view of the operator such that the recording includes the operator with respect to his surroundings.

### SUMMARY OF THE INVENTION

Briefly, the present invention is embodied in an articulating arm for retaining a camera to a two-wheel vehicle such as a bicycle. The articulating arm includes a removable clamp for gripping around a cylindrical surface and is preferably clamped around the cylindrical post of a bicycle seat. The removable clamp has a manual adjustment for selectively tightening and loosening the grip of the clamp around the cylindrical member such that the operator can rotate the clamp around the axis of the seat post when the clamp is loosened and will be resistive to rotation around the axis when the clamp is tightened.

The invention also includes a first arm having a first and second end with the first end of the first arm attached by a first connector to the clamp. The first connector allows the outer end of the first arm to be moveable in a plane that includes the axis of the cylindrical member or seat post to which the clamp is attached. The first connector includes a first lockable hinge having a locked condition and an unlocked condition. When the first lockable hinge is in the unlocked condition, the first arm is moveable with respect to the seat post and when the lockable hinge is in the locked position, the first arm is rigidly maintained with respect to the seat post.

The device includes a second arm having a first end and a second end, and a second connector joining the second end of the first arm to the first end of the second arm. The second connector includes a second lockable hinge having a locked condition and an unlocked condition such that the second arm is moveable about an axis perpendicular to the longitudinal axes of both the first arm and the second arm, while the second lockable hinge is in the unlocked condition. When the lockable hinge is in the locked condition, the second arm is maintained rigidly with respect to the first arm.

A mounting for retaining a camera is attached to the second end of the second arm by a third connector that also includes adjustable features and the ability to lock the camera into a desired angular orientation with respect to the arm. Preferably the camera mounting includes a ball joint that allows the camera to be rotatably adjusted about a vertical mounting axis of the camera (the vertical mounting axis being the axis around which lens will continuously photograph the surrounding environment in its upright orientation as the camera is rotated). The adjustable mounting includes a bolt that can be tightened to lock the camera in the desired orientation.

In the preferred embodiment, the clamp of the articulating arm is attached to the seat post of a bicycle and a video camera is mounted to the retainer at the end of the second arm. The first, second, and third connectors are adjusted to position the camera to provide the desired view as the camera moves through the surroundings with the bicycle. If the camera is directed toward the bicycle operator, the arms have sufficient length to space the video camera sufficiently far from the operator to allow the operator to be seen with respect to his surroundings. The rider can then photograph himself as he rides with the scene taken through the camera showing the rider and the bicycle with respect to the surrounding environment. The ride can set the camera to record prior to beginning a ride and the camera will photograph the rider, the bicycle he is riding, and his surroundings while the rider uses both hands to ride the vehicle and without requiring the rider to divert his attention to the operation of the camera.

### BRIEF DESCRIPTION OF THE DRAWINGS

A better understanding of the invention will be had after a reading of the following detailed description taken in conjunction with the drawings wherein:

FIG. 1 depicts a bicycle rider riding a bicycle having an articulating arm in accordance with the present invention, with the clamp of the articulating arm mounted to the seat post of a bicycle and a video camera mounted at the opposite end of the articulating arm;

FIG. 2 depicts the view as photographed through the camera mounted as shown in FIG. 1;

FIG. 3 depicts the bicycle and rider shown in FIG. 1 with the camera in a second orientation with respect to the rider;

FIG. 4 depicts the view as photographed by the camera while mounted as shown in FIG. 3;

FIG. 5 shows some of the various angle orientations permissible by the camera shown in FIGS. 1 and 3;

FIG. 6 depicts an enlarged view of the articulating arm shown in FIGS. 1 and 3;

FIG. 7 depicts a disassembled view of the quick release connector attaching the articulating arm to the bicycle; and

FIG. 8 depicts a camera mounting at the end of the second arm member of the articulating arm shown in FIGS. 1 and 3.

### DETAILED DESCRIPTION OF A PREFERRED EMBODIMENT

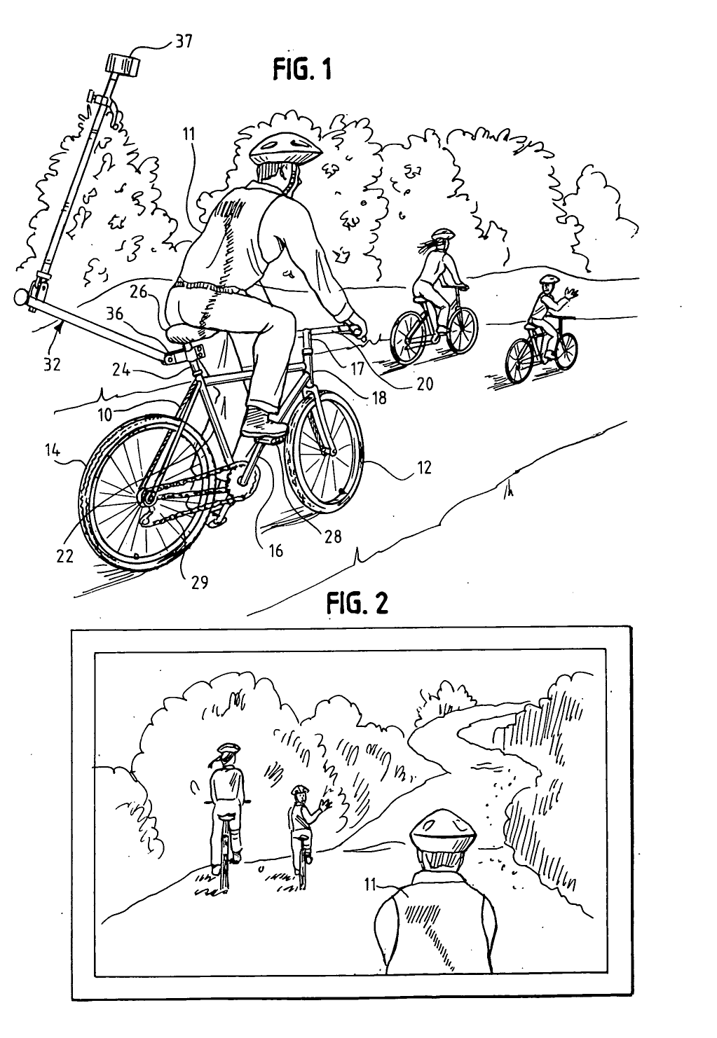

Referring to FIG. 1, a bicycle 10 has a front wheel 12, a rear wheel 14 and connecting the front and rear wheels a frame 16 made of tubular parts. Near the forward end of the frame is a upwardly extending steering post 17 that extends through a vertically oriented tubular retainer 18 and at the upper end of the steering post 17 are a pair of handlebars 20. Rearward of the handlebars 20 is another generally vertically oriented tubular post 22 and slideably retained within the rearward tubular post 22 is a downwardly extending seat post 24, the upper end of which is attached to the seat 26. A connector including an adjustable screw (not visible) at the upper end of the tubular post 22 can be tightened to retain the seat post 24 and the seat 26 mounted thereon at the desired elevation with respect to the frame 16, or loosened to allow vertical movement of the seat post 24 and seat with respect to the frame 16. At the bottom of the frame 16 between the front and rear wheels 12, 14 is a crank assembly including the pair of pedals 28, 29 for driving the rear wheel 14 by means of a chain 30.

The bicycle 10 comes in various standard sizes and a typical adult bicycle has a wheel diameter of approximately 28 inches. To accommodate adults of varying heights, the seat post 24 is sufficiently long to allow vertical adjustment of the seat 26 through a range of at least five or six inches.

To permit the rider 11 of the bicycle 10 to photograph the surroundings through which the bicycle travels and perhaps to photograph himself riding the bicycle, an articulating arm 32 has an axis 33 and one end 34 of the arm 32 connected by a clamp 36 to a portion of the seat post 24 that extends outward of the tubular post 22 and a camera 37 mounted to the second end 40.

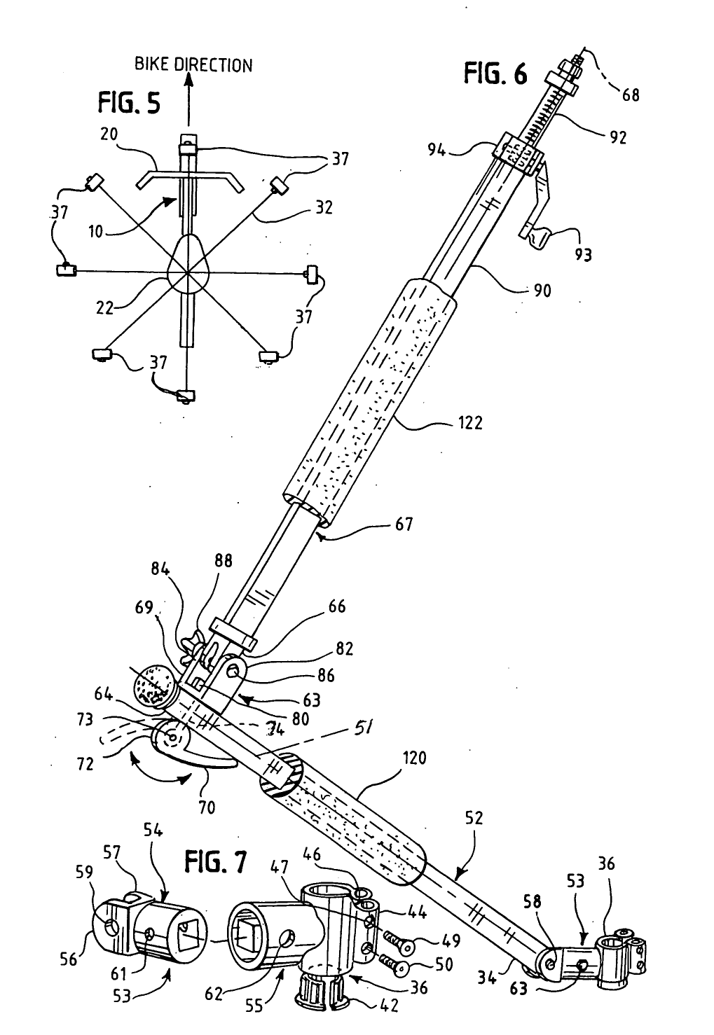

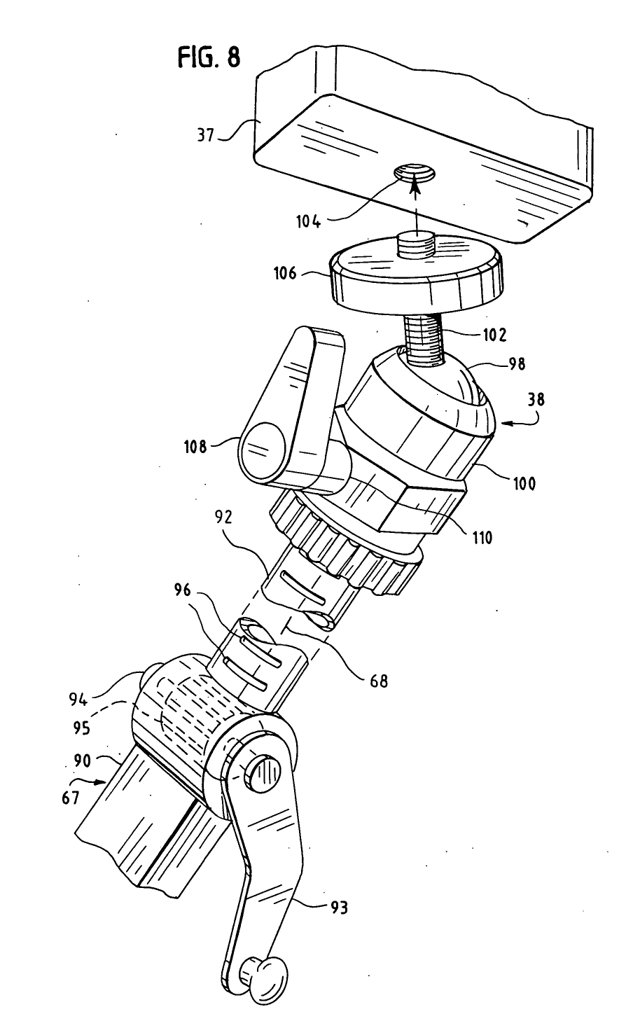

Referring to FIGS. 6 and 7, the clamp 36 is preferably configured as a C-shaped member adapted to receive a compressible sleeve 42 made of a flexible plastic. When assembled to the seat post 24, the end of the seat post 24 is inserted through the sleeve 42 and the sleeve 42 is fitted between the ends 44, 46 of the C-shaped member forming clamp 36. The ends 44, 46 have aligned transverse holes therein of which only the holes 47, 48 in end 44 are visible. A pair of locking bolts 49, 50 extend through the holes 47, 48 of the first end 44 and into complementary threading in the aligned holes of the second end 46. By tightening the locking bolts 48, 49 into the threaded holes in the second end 46, the first end 34 of the articulating arm 32 will be locked to the seat post 24 so as to be non-rotatable around the longitudinal axis of the seat post 24 except by the application of a relatively strong force, such as would occur if the second end 40 of the articulating arm 32 made contact with a person or a wall as the bicycle is moved across the ground. In the absence of an impact between some portion of a moving articulating arm 32 against a stationary object, the clamp 36 will rigidly retain the arm 32 in a fixed angular orientation with respect to the longitudinal axis of the seat post 24. Upon impact with a stationery object the outer end 40 of the articulating arm 32 will pivot around the seat post 24 to a rearward orientation thereby preventing serious injury to individuals or to the arm 32 and camera 37 mounted thereon.

Referring to FIGS. 1, 6, and 7, the articulating arm 32 includes of a first elongate arm member 52, having a longitudinal axis 51, the first end 34 of which is joined to the clamp 36 by an adjustable quick disconnect connector 53. The adjustable quick disconnect connector 53 includes a first portion 54 retained to the frame 16 of the bicycle 10 by the clamp 36 and a removable second portion 55 that is joined to the first end 34 of the first arm member 52 by an angularly adjustable connector in the form of a yoke have parallel spaced apart plates 56, 57. An adjustment bolt 58, visible only in FIG. 6, extends through a hole 59 in the first plate 56, through a transverse hole, not shown, in the distal end of the first arm member 52 and into a complementary threaded hole, not visible in the second plate 57. The first arm 52 is moveable through an arc about the axis of the bolt 58 in a plane that includes the axis of the seat post 22.

The locking bolt 58 can be tightened to retain the angular orientation of the longitudinal axis 60 of the first arm member 52 with respect to the clamp 36. On the other hand, when the bolt 58 is loosened, the first arm member 52 is easily manually adjusted through an arc to its desired orientation after which the bolt 58 can be tightened, locking the first arm member 52 in its desired orientation. For simplicity, the head of the bolt 58 can have an enlarged winged configuration so that it can be manually tightened or loosened without the use of tools.

The portions 54, 56 of the quick disconnect adjustable connector 53 include a rectangular core portion inside a tubular sleeve on the first portion 54 and complementarily shaped body on the second portion 55. Both portions 54, 55 have through holes 61, 62 respectively. When the portions 54, 55 are assembled together with the holes 61, 62 aligned, the parts are retained together by a retaining bolt 63, visible only in FIG. 6. The retaining bolt 58 can have a winged head allowing the operator to disconnect the portions 54 and 55 without the use of tools. Such quick release connectors 53 are well known in the art.

At the second end 64 of the first arm 52 is a second connector 65 that adjustably retains a first end 66 of a second arm member 67 having a longitudinal axis 68. The second connector 65 includes a yoke 69, the central portion of which is retained to the first arm member 52 by a quick release lever 70. The quick release lever 70 includes an arm attached to a pair of spaced apart cams 72 having off center aligned holes, and extending through the off center holes is a pin 73. The pin 73 rotatably retains one end of an elongate threaded locking stud 74 between the cams 72. The length of the threaded locking stud 74 shown in broken lines extends through the second end 64 of the first arm member 52 and into a hole, not visible, in the central portion of the yoke 69 and the parts are retained together by a nut 80. To attach the second connector 63 to the second end 64 of the first arm 52, the distal end of the locking stud 74 of the quick release lever 70 is extended through holes, not shown, in the tubular end 64 of the first arm 52 and through a transverse hole, not shown, in the central portion of the yoke 69, and is threaded into the complimentary nut 80. Once the nut 80 has been tightened as much as possible without the use of a tool, the quick release lever arm 70 can be rotated through an arc of up to one hundred and eighty degrees causing thicker portions of the cam 72 to be compressed against the surface of the second end 64 thereby significantly tightening the locking stud 74 and locking the second connector 65 to the second end 64 of the first arm member 42.

The second connector 64 also includes a pair of spaced apart plates 82, 84 with aligned transverse holes in each of the plates for receiving a locking bolt 86. The first end 66 of the second arm member 67 has a transverse hole, not visible therein. The first end 66 of the second arm 66 is fitted between the plates 82, 84 and the holes of the parts aligned to receive the locking bolt 86. A wing nut 88 or the like is fitted on the distal end of the locking bolt 86. The locking bolt 86 may be in the form of a carriage bolt, with the rectangular portion of the head locking into a rectangular transverse hole in one of the spaced plates 82 to prevent rotation of the locking bolt 86 while the wing nut 88 is tightened. When the wing nut 88 is tightened, the orientation of the second arm member 67 is locked with respect to the first arm member 52, and when the wing nut 88 is loosened, the second arm member 67 is moveable through an arc around the axis of the third locking bolt 86.

In the preferred embodiment, the second arm member 67 has at least two longitudinally adjustable tubular portions 90, 92 with the outer diameter of the second portion 92 being a little smaller than the inner diameter of the first portion 90 such that a first end of the second portion 92 may be inserted into a second end of the first portion 90 and the parts telescopically adjustable. A crank 93 rotates a shaft 94 on which a gear 95 is mounted for rotation therewith. The outer surface of the second tubular portion 92 has a plurality of spaced apart indentations 96-96 extending linearly along the length thereof and the spacings between adjacent indentations 96-96 are equal to the spacings of the ends of the teeth of the gear 95 around the circumference thereof. The teeth of the gear 95 are positioned so that at least one tooth always engages one of the indentations 96-96 such that rotation of the crank 93 in one direction causes the second portion 92 to be moved axially outward of the first tubular member 90 and rotation of the crank 93 in the opposite direction causes the second portion 92 to be moved axially inward of the first tubular member 90.

Attached to the distal end 40 of the second telescopic portion 92 is the adjustable camera mount 38. Camera mount 38 includes a pivot ball 98 mounted in a retainer 100 that is attached to the distal end of the second tubular member 92. The retainer 100 has an inner cavity, not visible, that is complementary to a little more than one half of the outer circumference of the pivot ball 98 such that the pivot ball 98 is retained within the retainer 100. A threaded stud 102 extends radially outward from the pivot ball 100 and the threadings on the stud 102 are complementary to the female threads of a threaded mounting hold 104 on a camera 37. The camera 37 is therefore attachable to the pivot ball 98 by threading the stud 102 into the mounting hole 104 of the camera 37. A locking nut 106 threaded on the threaded stud 102 can be screwed against the adjacent surface of the camera 37 to lock the camera in a desired orientation with respect to the pivot ball 98. Also, a locking bolt 108 has threads, not visible, that engage complementary threads in a hole 110 for tightening or loosening the grip of the retainer 100 around the mounting ball 98. Tightening the locking bolt 108 into the hole 110 causes the retainer 100 to tighten around the pivot ball 98 and thereby lock the orientation of the camera 37 with respect to the second arm member 67. When the locking bolt 108 is loosened, the orientation of the threaded stud is moveable as the pivot ball rotates within the retainer 98. Such pivot ball mountings to mount a camera are well known in the camera art.

The articulating arm 32 of the present invention is used by first removing the seat and seat post 22 of the bicycle 10 and inserting the seat post 24 through the sleeve 42 of the clamp 36 and tightening the bolts 49, 50 to orient the first arm 52 in its desired horizontal angular relationship to the bicycle 10 as shown in FIG. 5. Thereafter, a video camera 37 is attached to the threaded stud 102 and the nut 106 is tightened against the surface of the camera 37 locking it with respect to the stud 102. The vertical angle of the first arm member 52 with respect to the seat post 24 is then set and the parts are locked into their desired relationship by tightening the associated locking bolt 58. The desired angular orientation of the second arm 67 with respect to the first arm member 52 is likewise set and locked in place by tightening adjustment bolt 86 and wing nut 88. The length of the second arm 67 is set using the crank 93. The aim of the camera 37 is adjusted and locked into place using the pivot ball 98 and the locking bolt 108.

As shown in FIG. 6, the first and second arm members 52, 67 may be fitted within tubes 120, 122 of rubberized shock absorbing material to cushion any impact between bicycle mounted moving arm 32 and a stationary object such as a bystander or a tree.

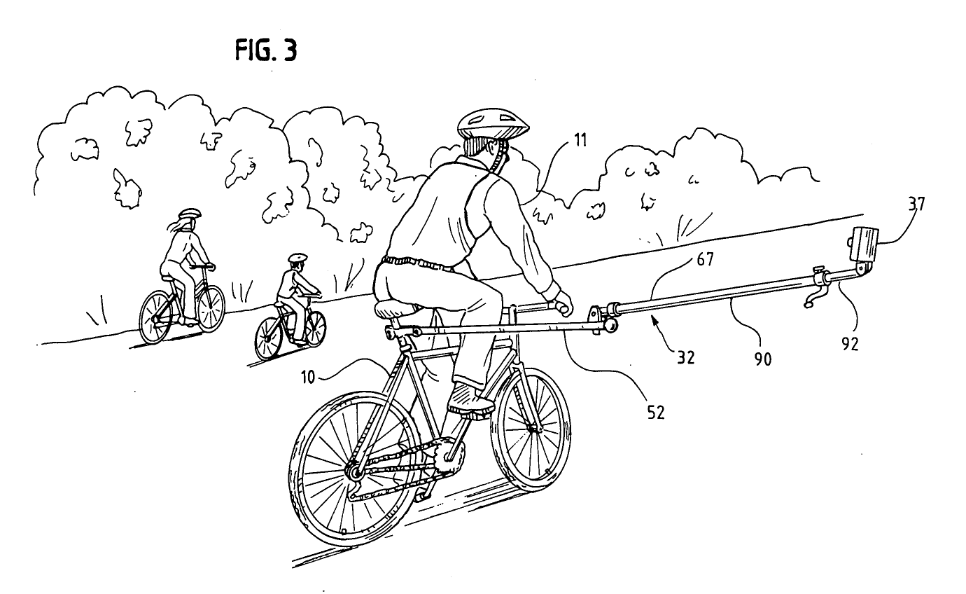

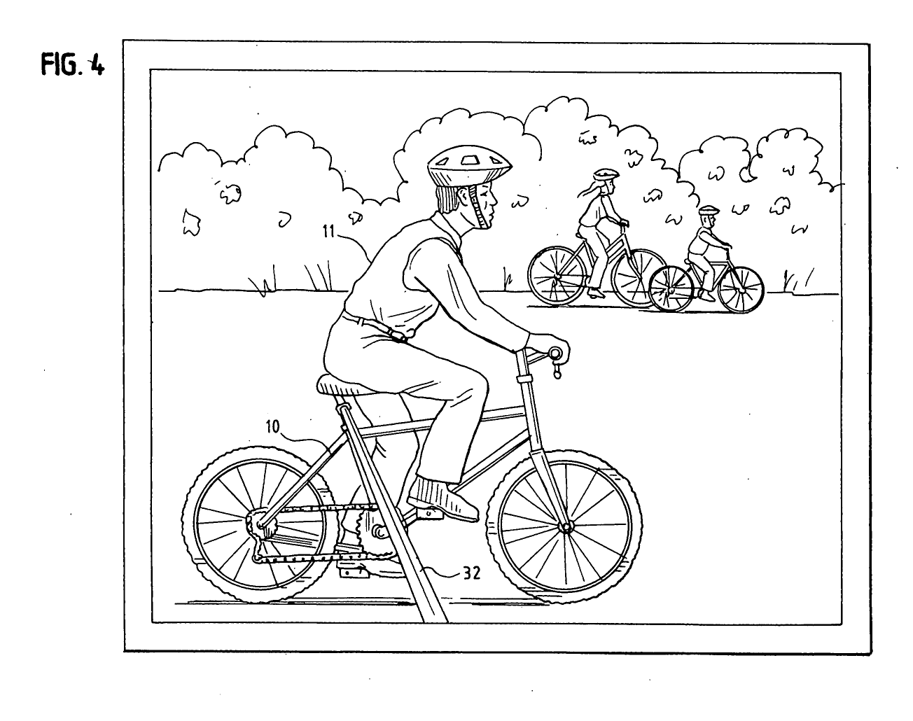

With the clamp 36 assembled to the seat post 24 of a bicycle 10, the length of the articulating arm 32 can be directed into any direction around the seat post 24 through 360 degrees, as shown in FIG. 5. The camera 37 can also be directed in any direction with respect to articulating arm 32, and some of the camera angles are also depicted in FIG. 5 although many more angles are available. It is desirable that the various arm members 52, 67 (including portions 90, 92) have lengths of two feet or more to allow the camera 37 to be spaced several feet away from the seat post 24 to which it is mounted. Preferably the members 52, 67 have a length of 2½ feet each. This permits the camera 37 to be aimed back at the rider 11. With the camera aimed at the rider 11, as shown in FIGS. 1 and 3, the recording made by the camera, as best shown in FIGS. 2 and 4, will depict the rider himself, along with the bicycle 10 as it moves through its surroundings. As shown in FIGS. 2 and 4, the scene as photographed by the camera can include the rider along with others riding along with him such that With the camera 37 aimed toward the bicycle 10, the articulating arm 32 will be in the view of the camera 37, but the arm 32 will occupy only a small portion of the useable frame and will offer little detraction to the view. The rider can therefor photograph himself as he rides, showing his surroundings, with having to release his grip on the handlebars of the bicycle. As shown in FIGS. 2 and 4, the scene as photographed by the camera can include the rider 11 along with others riding on other bicycles along with him and the scene is not dominated by the rider 11.

When the articulating arm 32 is not in use it can easily be removed from the bicycle 10 by releasing the portions 54, 56 of the quick release connector 53 from each other. Also the second quick release 70 can be used to quickly disassemble the first arm member 52 from the second arm member 67 to permit easy storage of the articulating arm 32.

The clamp 36 of the articulating arm 32 is attachable to any cylindrical member and the device is useable on any vehicle where the operation of the vehicle will consume the driver's or operator's full attention and require the use of both of his hands. It is best used on a bicycle, motorcycle, or the handlebar stem of a device with both wheels on the same axle, such as sold under the trademark SEGWAY, all of which are two wheeled vehicles and require both hands to operate correctly.

While the present invention has been depicted with respect to a single embodiment, it will be appreciated that many modifications and variations may be made without departing from the true spirit and scope of the invention. It is the intent therefore of the appended claims to cover all such modifications and variations which fall within the spirit and scope of the invention.

What is claimed:

1. An articulating arm for retaining a camera to a two wheeled vehicle comprising
a clamp for gripping a surface of an elongate member,
said clamp having a manual adjustment for selectively tightening and loosening said grip wherein said clamp is manually rotatable around an axis of said elongate member when said clamp is loosened and resistive to rotation around said axis when said clamp is tightened,
a first arm member having a first end, a second end and a longitudinal axis,
a first connector joining said first end of said first arm to said clamp,
said first connector including a first lockable hinge having a locked condition and an unlocked condition wherein said first arm member is moveable about an axis perpendicular to said longitudinal axis of said first arm member while said hinge is in said unlocked condition and is rigidly retained within said plane while said hinge is in said locked condition,
a second arm member having a first end, a second end and a longitudinal axis,
a second connector joining said second end of said first arm member to said first end of said second arm member,
said second connector including a second lockable hinge having a locked condition and an unlocked condition wherein said second arm member is moveable about an axis perpendicular to said longitudinal axis of one of said first arm member and said second arm member while said second lockable hinge is in said unlocked condition and said second arm member is rigidly maintained with respect to said first arm member while said second lockable hinge is in said locked condition,
a mounting for retaining a camera,
a third connector joining said mounting to said second end member of said second arm,
said third connector including a lockable adjustment having a locked condition and an unlocked condition wherein said mounting is moveable with respect to said second arm member while said lockable adjustment is in said unlocked condition and rigid with respect to said second arm member while in said locked condition,
a mounting for retaining a camera at said second end of said second arm member, and
said mounting allowing said camera to be aimed toward a rider of said wheeled vehicle wherein said rider can photograph himself with respect to a surrounding environment without releasing a grip on controls of said vehicle.

2. The articulating arm of claim 1 wherein one of said first arm member and said second is longitudinally extendable.

3. The articulating arm of claim 1 wherein said third connector includes a ball joint between said second end of said second arm member and said camera.

4. The articulating arm of claim 1 wherein said first lockable hinge includes a threaded bolt that is tightened to lock said hinge and loosened to unlock said hinge.

5. The articulating arm of claim 1 wherein said mounting for retaining a camera is a pivot mounting.

6. The articulating arm of claim 1 wherein said mounting for retaining a camera and said second lockable hinge allows said camera to be aimed back toward said clamp.

7. The articulating arm of claim 1 wherein said first arm member and said second arm member each have a length of at least two feet.

8. The articulating arm of claim 1 and further comprising a quick release between said clamp and said first end of said first arm member wherein said first arm member can be disconnected from said clamp without the use of tools.

9. The articulating arm of claim 1 and further comprising a quick release between said first arm member and said second arm member wherein said first and second arm members are detachable from one another without the use of tools.

10. An articulating arm for retaining a camera to a two wheeled vehicle comprising
a clamp for retaining said arm to a member of said vehicle,
a first arm member having a first end and a second end,
said first end of said first arm member connected to said clamp,
a second arm member having a first end and a second end,
a connector connecting said second end of said first arm member to said first end of said second arm member,
a mounting for retaining a camera at said second end of said second arm member,
said first arm member and said second arm member each having a length of at least two feet, and
said connector and said mounting allowing an angular orientation between said parts wherein said camera con be directed toward a rider of said vehicle and said camera is spaced far enough from said rider for said camera wherein said rider can photograph himself with respect to a surrounding environment without releasing his grip on control handles of said vehicle.

11. The articulating arm of claim 10 wherein one of said first arm and said second is longitudinally extendable.

12. The articulating arm of claim 10 wherein said third connector includes
a ball joint between said second end of said second arm and said camera.

13. The articulating arm of claim 10 wherein said first lockable hinge includes a threaded bolt that is tightened to lock said hinge and loosened to unlock said hinge.

14. The articulating arm of claim 10 wherein said mounting for retaining a camera is a pivot mounting.

15. The articulating arm of claim 10 wherein said mounting for retaining a camera and said second lockable hinge allow adequate movement for said camera to be directed back toward said clamp for...

16. The articulating arm of claim 10 wherein said first arm sand said second arm each have a length of at least two feet.

17. The articulating arm of claim 10 and further comprising a quick release between said clamp and said first end of said first arm wherein said first arm can be disconnected from said clamp without the use of tools.

18. The articulating arm of claim 10 and further comprising a quick release between said first arm member and said second arm member wherein said first and second arm members are detachable from one another without the use of tools.
